(19) United States
(12) Patent Application Publication
(10) Pub. No.: US 2023/0026712 A1
(43) Pub. Date: Jan. 26, 2023

(54) GENERATING SYSTEM MEMORY SNAPSHOT ON MEMORY SUB-SYSTEM WITH HARDWARE ACCELERATED INPUT/OUTPUT PATH

(71) Applicant: Micron Technology, Inc., Boise, ID (US)

(72) Inventor: Noorshaheen Mavungal Noorudheen, Chavakkad (IN)

(21) Appl. No.: 17/383,152

(22) Filed: Jul. 22, 2021

(51) Int. Cl. G06F 3/06; G06F 11/14

(52) U.S. Cl. CPC G06F 3/065; G06F 11/1451; G06F 3/0619; G06F 3/0688; G06F 2201/82; G06F 2201/84

(57) ABSTRACT

A description of a snapshot to be generated is received by a local media controller of a memory device, from a memory sub-system controller. The description comprises a memory address range of a memory device. Responsive to detecting a triggering event, a snapshot of the memory address range of the memory device is generated in view of the description. The snapshot is stored to a destination address. The memory sub-system controller is notified of the triggering event.

### TECHNICAL FIELD

Embodiments of the disclosure relate generally to memory sub-systems, and more specifically, relate to generating a system memory snapshot on a memory sub-system with a hardware accelerated input/output path.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1A illustrates an example computing system that includes a memory sub-system in accordance with some embodiments of the present disclosure.

FIG. 1B illustrates the example computing system of FIG. 1A in additional detail, including a memory device with accelerated input/output path, in accordance with some embodiments of the present disclosure.

FIG. 1C illustrates an example computing system of FIG. 1A in additional detail, including a memory sub-system with accelerated input/output path, in accordance with some embodiments of the present disclosure.

FIG. 2 depicts a block diagram illustrating an implementation of a method executed by a computer system for generating a snapshot of a memory sub-system with hardware accelerated input/output path, in accordance with some embodiments of the present disclosure.

FIG. 3 is a flow diagram of an example method to generate a snapshot of a memory device with hardware accelerated input/output path, in accordance with some embodiments of the present disclosure.

FIG. 4 is a flow diagram of an example method to generate a comprehensive snapshot of a memory sub-system with hardware accelerated input/output path, in accordance with some embodiments of the present disclosure.

FIG. 5 is a block diagram of an example computer system in which embodiments of the present disclosure may operate.

### DETAILED DESCRIPTION

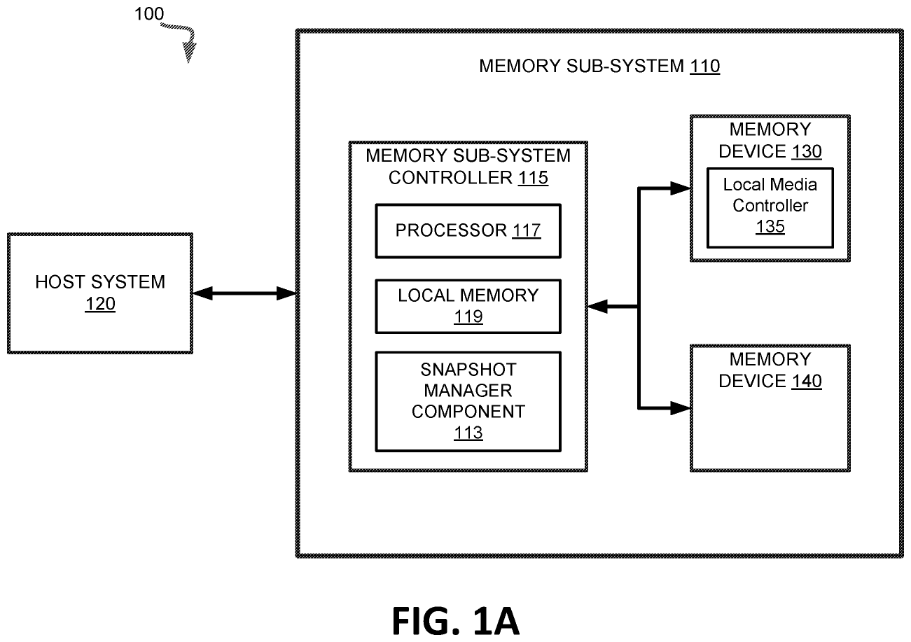

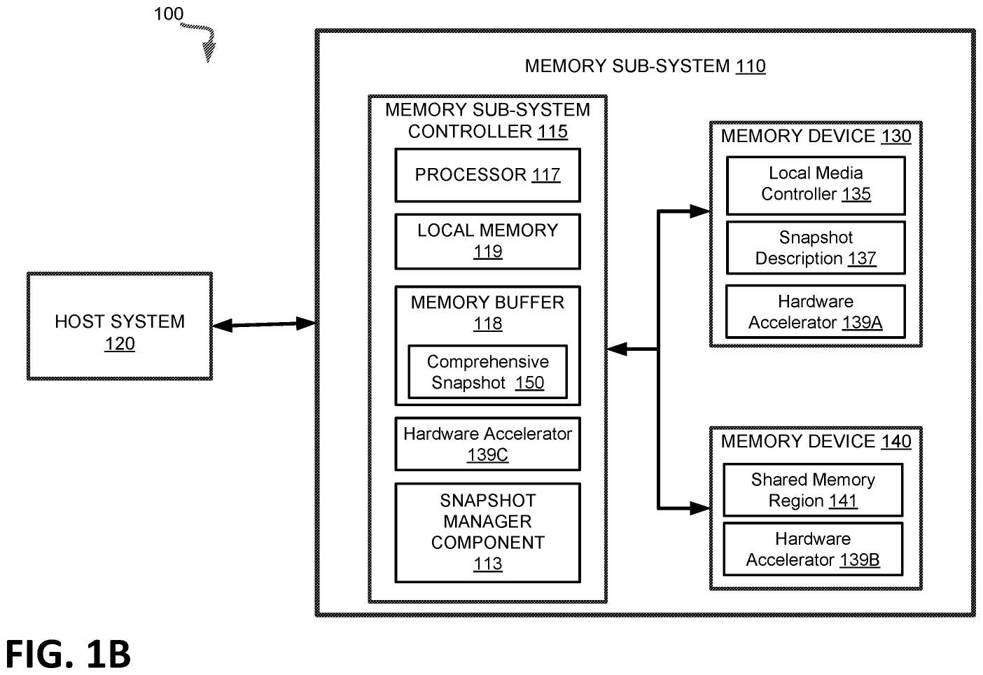

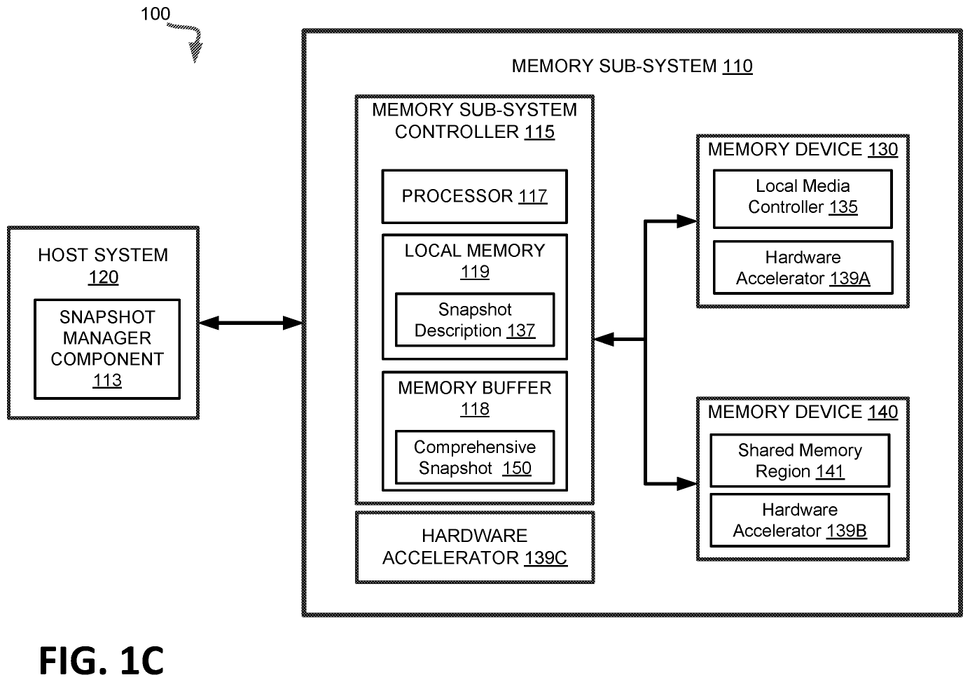

Aspects of the present disclosure are directed to generating a system memory snapshot on a memory sub-system with a hardware accelerated input/output path in order to obtain point-in-time debug information. A memory sub-system can be a storage device, a memory module, or a combination of a storage device and memory module. Examples of storage devices and memory modules are described below in conjunction with FIG. 1A. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIG. 1A. A non-volatile memory device is a package of one or more dies. Each die can consist of one or more planes. For some types of non-volatile memory devices (e.g., NAND devices), each plane includes a set of physical blocks. Each block includes a set of pages. Each page includes a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

Debugging can involve finding and reducing the number of defects (i.e., “bugs”) in an electronic device, such as a memory sub-system. Various debugging techniques can be used to detect anomalies, assess their impact, and schedule hardware changes, firmware upgrades, or full updates to a system. The goals of debugging include identifying and rectifying defects in the system (e.g., logical or synchronization problems in the firmware, or a design error in the hardware), and collecting system state information. System state information can include information about the operation of the memory sub-system, including contents of internal processor registers (which can include a program counter and a stack pointer, for example), memory management information, metadata tables, and/or certain memory address ranges. System state information can include, but is not limited to, hardware registers, peripheral registers, a hardware log area, hardware internal state machines, and hardware error registers. The system state information can be used to analyze the memory sub-system to find ways to boost its performance or to optimize other important characteristics.

One example of system state information can include event data generated in the memory sub-system. An event, as used herein, generally refers to a detectable change of state caused by an action performed by hardware, software, firmware, or a combination of any of the above in the memory sub-system. Examples of events include a memory sub-system controller sending and/or receiving data or accessing a memory location of a memory device, a warning related to some reliability statistic (e.g., raw bit error rate (RBER)) of a memory device, an error experienced by the memory sub-system controller in reading data from or writing data to a memory device, etc.

Point-in-time debug information can be important to analyzing events being reported from customer use and/or during the qualification of the memory sub-system. Debug information can include a snapshot of the state of the memory sub-system and/or of a memory device within the memory sub-system, generated during the time that the reported issue occurred (e.g., during the event that caused an error or failure within the memory sub-system). A snapshot can be a copy of the state of the memory sub-system and/or of a memory device at a certain point in time. A snapshot can include a copy of certain memory regions of a memory device, for example, a copy of the state of certain registers at a certain point in time. Analyzing the debug information can help determine the root cause of the issue. In order to generate a snapshot during the event that caused the reported issue (e.g., during a hardware failure), each processor core saves a copy of its hardware registers and/or other important regions of memory. This combination of data is sometimes referred to as a core dump.

Thus, the core dump captures the last moments of a given runtime cycle of a memory sub-system in the event of a software and/or hardware failure. More specifically, the core dump captures data from a set of memory addresses, and saves the data to a designated persistent memory region. The information from the core dump can then be analyzed to determine the state of the memory sub-system at the time of the failure.

However, for memory sub-systems with hardware accelerated input/output paths, this core dump process can result in an inaccurate snapshot of the memory sub-system. In order to accelerate read and write commands, memory sub-systems with hardware accelerated I/O paths enable read and write commands to be directed through the hardware of the memory sub-system, thus bypassing the firmware. As a result, the firmware can be unaware of issues that arise within the hardware. I/O paths between the host system and the memory sub-system can be accelerated, and I/O paths within the memory sub-system (i.e., between the memory sub-system controller and a memory device) can be accelerated. When an issue arises, the hardware reports the event to the processor, for example, by generating an interrupt. After receiving the interrupt, the processor initiates the snapshot process and copies the hardware registers and other important memory regions to a shared memory region. In some embodiments, the data copied from the hardware registers can be formatted in an executable and linkable format (ELF) core dump. The time elapsed between the interrupt and the processor's response is not insignificant; for example, the time elapsed between the two events can be in the order of milliseconds based on the interrupt latency and the processor response time. The processor response time can vary based on the activity the processor is engaged in during the time of the error event. During this time (that is, in the milliseconds between the interrupt and the processor response time), the system and state of memory space can undergo significant changes. Thus, the snapshot captured by the snapshot process described above can be an inaccurate representation of the state of the system and memory at the time that the error event occurred. That is, in some firmware-based implementations, by the time hardware notifies the firmware of the triggering event, the hardware states might have already changed, and the hardware state may not reflect the failure as the memory and hardware registers are overwritten due to the delay in notifying the firmware.

Aspects of the present disclosure address the above-noted and other deficiencies by enabling the hardware with accelerated I/O to perform the snapshot process. Upon initialization of the memory sub-system, the memory sub-system controller can send, to memory devices within the memory sub-system a description of a snapshot to generate in response to a triggering event. A triggering event can be an error or failure that triggers the snapshot generation process. The memory sub-system controller can also designate shared memory regions for storing the generated snapshots. The description of the snapshot to be generated in the event of a triggering event can be built into the hardware with accelerated I/O. Thus, the hardware with accelerated I/O can generate and store the snapshot according to the description in response to a triggering event, without intervention from the memory sub-system controller. At the time of generating the snapshot, the hardware memory, logs, and registers are intact and give the correct hardware failure as the snapshot is initiated immediately.

Upon initialization of the hardware, the memory sub-system controller provides, to the hardware, a description of the snapshot to be generated in response to detecting a triggering event. The description can include identifiers of specific registers and/or of memory regions of debug data to be captured by the hardware upon detection of a triggering event. For example, the memory sub-system controller can provide a list of physical address ranges that the hardware is to capture. The memory sub-system controller can also provide the physical address of the designated shared memory region to which the hardware is to store the captured data.

The description can be provided to the controller of any device that has hardware accelerated I/O path, such as a memory device controller, a memory sub-system controller, or a network controller. In some embodiments, the memory sub-system controller can provide the description of the snapshot to a local media controller of a memory device that has hardware accelerated I/O. The description can include a list of triggering events, such as a list of error codes that trigger generation of a snapshot. The error codes can represent fatal errors that cause a process to terminate unexpectedly. In some embodiments, the triggering events can include an device failure detected by the memory device controller. Thus, in the event of a failure, error, or other triggering event, the memory device can immediately snapshot debug registers and/or other memory regions specified in the description to the designated shared memory region. This snapshot data can accurately represent the state of the memory device at the time of the triggering event. The local media controller of the memory device can also report the error to the memory sub-system controller. The memory sub-system controller can initiate its own snapshot process in order to capture the state of the memory regions to which the local media controller that detected the triggering event does not have access. The memory sub-system controller can then aggregate the snapshots to produce a comprehensive system snapshot of the memory sub-system at the time of the event.

In some embodiments, a memory sub-system can have hardware accelerated I/O. The memory sub-system can store a description of a snapshot to be generated in response to detecting a triggering event. Thus, in the event of a failure, error, or other triggering event, the memory sub-system can snapshot debug registers and/or other memory regions specified in the description to the designated shared memory region. The memory sub-system controller can also report the triggering event to the host system, which can initiate a snapshot process of capture the state of the other memory sub-systems within the computer system.

Advantages of the present disclosure include, but are not limited to, providing an improved system snapshot taken during a hardware failure or other triggering error event that matches the exact time of the event. This snapshot provides improved point-in-time debug information, which can be used to determine the root cause of the issue that led to the failure. Aspects of the present disclosure provide reduced latency in capturing the debug state (registers, memory, and/or debug information) by enabling the hardware to snapshot internal debug memory regions without firmware intervention. The resulting point-in-time debug information matches the time at which the issue occurred within the hardware, thus reducing latency related to the snapshot process and providing more accurate debug data on which to perform failure analysis for memory sub-systems that have a hardware accelerated I/O path.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a snapshot manager component 113 that can implement a hardware-generated snapshot process. In some embodiments, the memory sub-system controller 115 includes at least a portion of the snapshot manager component 113. In some embodiments, the snapshot manager component 113 is part of the host system 120, an application, or an operating system. In other embodiments, local media controller 135 includes at least a portion of snapshot manager component 113 and is configured to perform the functionality described herein.

The snapshot manager component 113 can generate a comprehensive snapshot of the memory sub-system upon a triggering event. Upon initialization of the memory sub-system 110, the snapshot manager component 113 can designate a portion of memory as a shared memory region, to which the memory devices 130, 140 can store snapshots. In some embodiments, the shared memory region can be volatile memory, e.g., at memory device 140. Upon initialization of the memory sub-system 110, the snapshot manager component 113 can also send a description of the snapshot to be generated in response to a triggering event to each memory device 130, 140. The description of the snapshot can include a list of memory address ranges within the respective memory device 130, 140, a copy of which the respective memory device is to include in the snapshot. For example, the list of memory address ranges can point to debug registers within the memory device. In some embodiments, the list of memory address ranges can include one or more starting memory addresses, followed by a size of memory to be captured during the snapshot. The description of the snapshot can also include the destination address designated by the snapshot manager component 113.

The local media controller 135 of memory device 130 can store the description of the snapshot. In some embodiments, the description of the snapshot can be included in the control logic of memory device 130. The description can include a list of events that trigger generation of a snapshot. Triggering events can include a device failure or an error, such as an error that causes a program to abort, an error related to accessing invalid code or invalid data, or an error related to a process that terminated unexpectedly. An example list of triggering events includes non-volatile memory express (NVMe) command timeout, NVMe state machine error, NVMe internal error, NVMe parity error, reset, link down, CRC error, and PCIe AXI error. Upon detecting a triggering event, the local media controller 135 can immediately generate a snapshot of the memory device 130 using the specifications included in the description. Specifically, the local media controller 135 can identify the memory address ranges specified in the description, and copy the specified memory address ranges to generate a snapshot. The local media controller 135 can store the generated snapshot to the designated shared memory region specified in the description. The local media controller 135 can then notify snapshot manager component 113 of the triggering event, for example by sending an interrupt to the memory sub-system controller 115. The snapshot manager component 113 can then generate snapshots of other memory devices of the memory sub-system 110 to which local media controller 135 does not have access. For example, snapshot manager component 113 can send instructions to memory device 140 to generate a snapshot of certain memory regions within memory device 140. Snapshot manager component 113 can also generate a snapshot of internal registers of the memory sub-system controller 115. Snapshot manager component 113 can aggregate the snapshots by combining the snapshot generated by local media controller 135 and the additional snapshots generated by snapshot manager component 113 to create a comprehensive snapshot of the memory sub-system 110. The snapshot manager component 113 can store the comprehensive snapshot to persistent memory. In some embodiments, the snapshot manager component 113 can store the comprehensive snapshot to an area of persistent memory implemented as a power protected volatile memory device (e.g., power protected dynamic random-access memory (DRAM)). After successfully storing the comprehensive snapshot to a persistent memory device, the snapshot manager component 113 can notify the local media controller 135 that the snapshot has been successfully stored.

In some embodiments, snapshot manager component 113 can notify the host system 120 of the triggering event. The notification can include an indication that the comprehensive snapshot has been successfully stored to persistent memory. Further details with regards to the operations of the snapshot manager component 113 are described below.

FIG. 1B illustrates the example computing system 100 of FIG. 1A in additional detail, including a memory device with accelerated input/output path that can generate a snapshot, in accordance with some embodiments of the present disclosure. In embodiments, memory device 130, 140, and/or memory sub-system 110 can have hardware accelerated input/output paths. A hardware accelerated input/output path enables input/output to be sent directly from a processor to the hardware, bypassing the firmware. In embodiments, memory sub-system controller 115 and/or memory devices 130, 140 can include hardware accelerator 139C, 139A, 139B (respectively). Hardware accelerators 139A-C can be the same, or hardware accelerators 139A-C can each be different from each other. Hardware accelerators can include hard-coded logic to perform input/output commands, enabling I/O paths that bypass the firmware of the controller. In embodiments, hardware accelerator 139C of memory sub-system controller 115 can receive input/output data from host system 120 and can direct the data to the appropriate memory device 130, 140. In some embodiments, hardware accelerator 139A, 139B of memory device 130, 140 can receive input/output commands from the memory sub-system controller 115, thus bypassing the local media controller 135A, 135B (respectively). In some embodiments, hardware accelerator 139A, 139B can receive input/output commands from hardware accelerator 139C of the memory sub-system controller 115.

Memory sub-system controller 115 can include a snapshot manager component 113. Snapshot manager components 113 can perform the same functions as snapshot manager component 113 of FIG. 1A. Snapshot manager component 113 of memory sub-system controller 115 can send, to a memory device 130, 140, a description of a snapshot to be generated in the event of a triggering event, such as an error or a device failure. In some embodiments, memory device 130 can stored the received the description of the snapshot to be generated in the event of a triggering event at snapshot description 137. In some embodiments, the snapshot description 137 can include a list of events that will trigger generation of a snapshot. The list of events can be error codes that memory device 130 can experience. The snapshot description 137 can also include the memory address ranges of memory device 130 that memory device 130 is to copy to generate the snapshot. In some embodiments, the snapshot description 137 can include a list of starting memory addresses, and the corresponding sizes of memory to capture. For example, the snapshot description 137 can include a list of starting physical addresses within memory device 130, each starting physical address followed by a size (e.g., 256K). Hence, to generate the snapshot according to snapshot description 137, memory device 130 can copy the specified amount of memory following each starting address in the list (e.g., the 256K of memory following the starting physical address).

The snapshot description 137 can include a destination address at which to store the generated snapshot (i.e., at which to store the copied the memory address ranges). The destination address can specify the shared memory region designated by the snapshot manager component 113 of the memory sub-system controller 115. For example, the snapshot manager component 113 can designate shared memory region 141 of memory device 140, and the destination address included in snapshot description 137 can point to shared memory region 141. Hence, in response to detecting one of triggering events listed in snapshot description 137, memory device 130 can generate a snapshot that includes a copy of the memory regions defined in snapshot description 137, and can store the snapshot at shared memory region 141.

In some embodiments, the snapshot description 137 can include an availability indicator that indicates whether the shared memory region 141 is available. The shared memory region 141 is not available if it is currently storing a snapshot that has not been stored to persistent memory. Hence, prior to generating the snapshot, local media controller 135 can determine whether the shared memory region 141 is available by inspecting the availability indicator. Upon generating and storing the snapshot at shared memory region 141, the local media controller 135 can update the availability indicator to indicate that the shared memory region 141 is not available.

Snapshot description 137 can include an instruction to send a notification to snapshot manager component 113 following storing of the snapshot. Hence, after storing the snapshot at shared memory region 141, local media controller 135 can send a notification to snapshot manager component 113. The notification can be an interrupt. The notification can include an identification of the triggering event (e.g., the error code that triggered the snapshot process). The snapshot manager component 113, in response to receiving a notification from local media controller 135, can initiate a snapshot process of the rest of the memory sub-system to which the faulting memory device 130 does not have access. That is, in response to receiving a notification of an error from memory device 130, snapshot manager component 113 can send instructions to memory device 140 to generate a snapshot. In some embodiments, the snapshot manager component 113 can send specific instructions to generate the snapshot of memory device 140. Additionally or alternatively, snapshot manager component 113 can generate a snapshot of local memory 119 in response to receiving a notification of a failure from memory device 130.

The snapshot manager component 113 can then aggregate the generated snapshots of memory device 130 stored at shared memory region 141, and the additional generated snapshots of memory device 140 and/or of local memory 119, to create a comprehensive snapshot of the state of the memory sub-system 110. The comprehensive snapshot can be stored in persistent memory. In some embodiments, the comprehensive snapshot 150 can be stored in a memory buffer 118. After storing the comprehensive snapshot to persistent memory, the snapshot manager component 113 can notify the local media controller 135 that the snapshots have been successfully stored. Local media controller 135 can then reuse the shared memory region 141 for future snapshots. That is, upon receiving a notification from snapshot manager component 113 that the comprehensive snapshot has been successfully stored to persistent memory, local media controller 135 can update the availability indicator to indicate that shared memory region 141 is available.

FIG. 1C illustrates an example computing system of FIG. 1A in additional detail, including a memory sub-system with accelerated input/output path that can generate a snapshot, in accordance with some embodiments of the present disclosure. In embodiments, memory device 130, 140, and/or memory sub-system 110 can have hardware accelerated input/output paths. A hardware accelerated input/output path enables input/output to be sent directly from a processor to the hardware, bypassing the firmware. In FIG. 1C, memory sub-system 110 can include hardware accelerator 139C. The hardware accelerated 139C can receive input/output commands from host system 120, thus bypassing the firmware of memory sub-system controller 115.

In some embodiments, host system 120 can perform the functions of snapshot manager component 113 as described above. Specifically, snapshot manager component 113 can reside on the host system 120. The host system 120 can designate a portion of the memory sub-system 110 as the shared memory region, such as shared memory region 141 of memory device 140. The host system 120 can send, to memory sub-system 110, a description of a snapshot to be generated upon detection of a triggering event. The memory sub-system controller 115 can store the snapshot description 137 in local memory 119. In some embodiments, the snapshot description 137 can include a list of triggering events, such as fatal errors or device failures. Upon detecting one of the triggering events, the memory sub-system can execute the instructions in the snapshot description 137 to generate a snapshot of the memory sub-system 110. For example, the memory sub-system controller 115 can identify the memory address ranges included in the snapshot description 137. The memory address ranges can point to memory device 130, 140, and/or local memory 119. The memory sub-system controller 115 can create a copy of the memory address ranges, and store the copied memory address ranges in the shared memory region 141. In some embodiments, the memory sub-system controller can aggregate the copied memory address ranges to generate a comprehensive snapshot, and can store the comprehensive snapshot 150 in memory buffer 118. The memory sub-system controller can notify host system 120 of the event that triggered the snapshot. In some embodiments, the host system 120 can initiate a snapshot of any other memory sub-systems associated with host system 120 (not pictured).

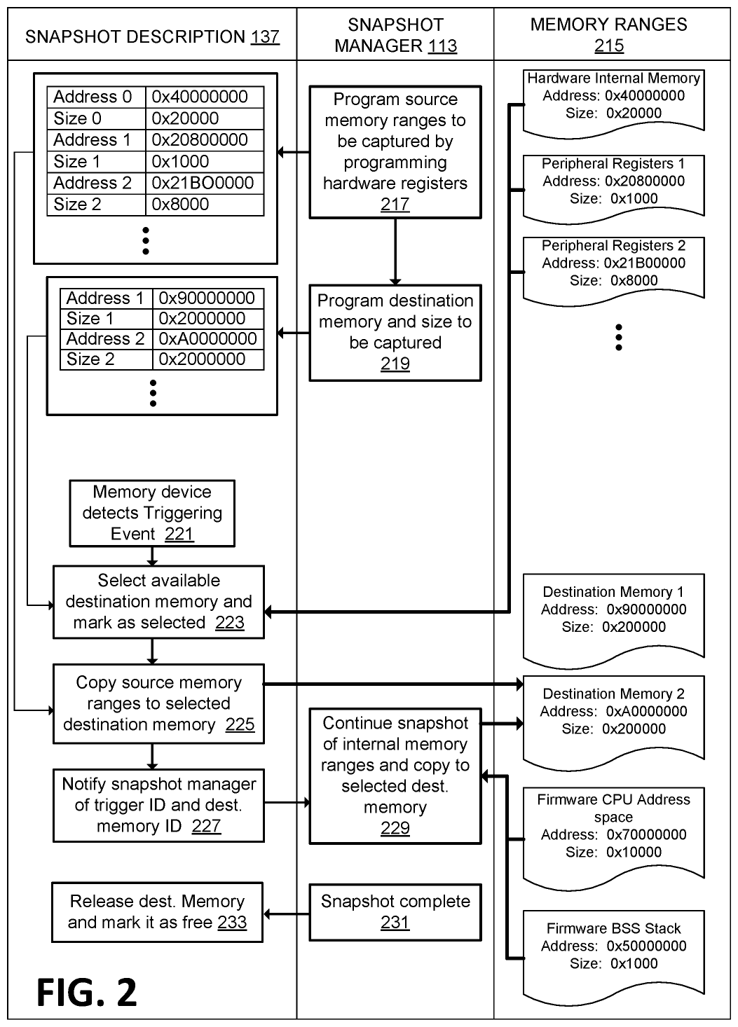

FIG. 2 depicts a block diagram illustrating an implementation of a method 200 executed by a computer system for generating a snapshot of a memory sub-system with hardware accelerated input/output path, in accordance with some embodiments of the present disclosure. The method 200 can be implemented by computing system 100 of FIGS. 1A-1C. In some embodiments, and with regards to the following description of FIG. 2, snapshot manager 113 can be part of memory sub-system controller 115 of FIGS. 1A, 1B, and snapshot description 137 can be part of memory device 130 of FIG. 1B. It should be noted that in some embodiments, snapshot manager 113 can be part of the host system 120 FIG. 1C, and snapshot desertion 137 can be part of the memory sub-system controller 115 of FIG. 1C. In some embodiments, memory ranges 215 can include internal memory of memory devices and peripheral registers of memory devices 130, 140 of FIGS. 1A-1C, and memory buffer 118 of FIGS. 1B, 1C.

Upon initialization, at operation 217, the snapshot manager 113 can program source memory ranges to be captured by programming hardware registers. Snapshot manager 113 can send to snapshot description 137 of memory device 130 a description of a snapshot to generate in response to detecting a triggering event. The description of the snapshot can include hardware registers and/or specific memory address ranges of the memory device 130 to include in the snapshot. As illustrated in FIG. 2, in some embodiments, the description can include a list of starting memory addresses (e.g., a list of logical block addresses within hardware 201, or a list of physical addresses within hardware 201), illustrated as Address 0 through Address 2, as well as a size corresponding to each starting address, illustrated as Size 0 through Size 2. Note that the list of starting addresses and sizes is not limited to three, and in most implementations will include many more addresses and corresponding sizes. The starting address can point to a physical address within memory device 130, and the size can indicate how much data to snapshot starting at the starting address.

At operation 219, the snapshot manager 113 can program destination memory addresses and sizes to be captured. As illustrated in FIG. 2, snapshot manager 113 programs two destination memory addresses and corresponding sizes. The destination memory addresses can have an associated availability indicator, indicating whether the destination address is available. The destination addresses can point to persistent memory, e.g., to memory buffer 118 of memory sub-system 110 in FIGS. 1B-C.

In some embodiments, receiving an error included in the list of triggering events can automatically trigger the generation of a snapshot according to the instructions stored in snapshot description 137. In some embodiments, the description stored in memory device 130 can monitor the errors of memory device 130 and if an error matches one of the triggering events, the processing logic of memory device 130 can execute the instructions included in the description of the snapshot. As illustrated in FIG. 2, at operation 221, memory device 130 can detect a triggering event. A triggering event can be a hardware failure, or an error with regard to the input/output path, for example. In embodiments, the snapshot description 137 can include a list of triggering events that would trigger a snapshot. The list of triggering events can include a list of error codes or trigger identification codes that memory device 130 can experience. The snapshot description 137 can include instructions that automatically initiate the snapshot generation process upon detecting one of the triggering events.

At operation 223, in response to detecting the triggering event, the processing logic of memory device 130, in view of snapshot description 137, determines if any of the registered destination memory addresses are available. The processing logic of memory device 130 can check the availability indicator associated with the destination addresses to determine the availability of the memory addresses. At operation 223, the processing logic of memory device 130 selects one of the available destination memory addresses and marks the destination memory address as selected. For example, the processing logic of memory device 130 can select destination memory 2, and update the availability indicator associated with destination memory 2 to indicate that the destination memory is not available.

At operation 225, in embodiments, the processing logic of memory device 130 iterates through all the registered source address ranges and copies them to the destination space. In some embodiments, the processing logic copies the source memory ranges to the destination space one by one. As illustrated in FIG. 2, the processing logic of memory device 130, in view of snapshot description 137, identifies address 0 and size 0 as the first source memory address to copy. The processing logic copies the data stored at address 0 and size 0 (illustrated as hardware internal memory in FIG. 2) and stores the data in the selected destination address, i.e., destination memory 2. The processing logic then identifies address 1 and size 1 as the second source memory address to copy, and copies the data stored at address 1 and size 1 (illustrated as peripheral registers 1 in FIG. 2) to destination memory 2, and so on.

At operation 227, the processing logic of memory device 130 notifies the snapshot manager 113 of the triggering event and the destination memory selected. In some embodiments, the processing logic can send the trigger ID and the destination memory ID (e.g., destination memory 2 in FIG. 2) to snapshot manager 113. In embodiments, the processing logic of memory device 130 can notify the snapshot manager 113 by sending an interrupt to the memory sub-system controller 115. The notification (e.g., the interrupt) can include the trigger identification (ID) or error code, which identifies the type of triggering event (e.g., error or failure). In embodiments, the trigger ID can specify which additional hardware devices to snapshot.

At operation 229, snapshot manager 113, in response to receiving the notification of the triggering event, continues the snapshot process by generating a snapshot of internal memory ranges to which the memory device 130 does not have access. Hence, at operation 229, snapshot manager 113 snapshot internal memory ranges and copies them to the selected destination memory. For example, as illustrated in FIG. 2, snapshot manager 113 copies firmware CPU address space and firmware BSS stack to the destination memory 2.

At operation 231, the snapshot process is complete. In some embodiments, destination memory 2 is volatile memory, in which case the snapshot manager 113 can store the snapshot from destination memory 2 to persistent or non-volatile memory before completing the snapshot process. Once the snapshot process is complete, snapshot manager 113 can release the selected destination memory address by marking it as available in snapshot description 137. For example, to continue the example in FIG. 2, snapshot manager 113 can update the availability indicator associated with destination memory 2 to indicate that destination memory 2 is available. In some embodiments, snapshot manager 113 can send a notification to memory device 130 indicating that the snapshot process in complete. In response to receiving the notification, the processing logic of memory device 130 can update the availability indicator associated with the selected destination memory (i.e., destination memory 2).

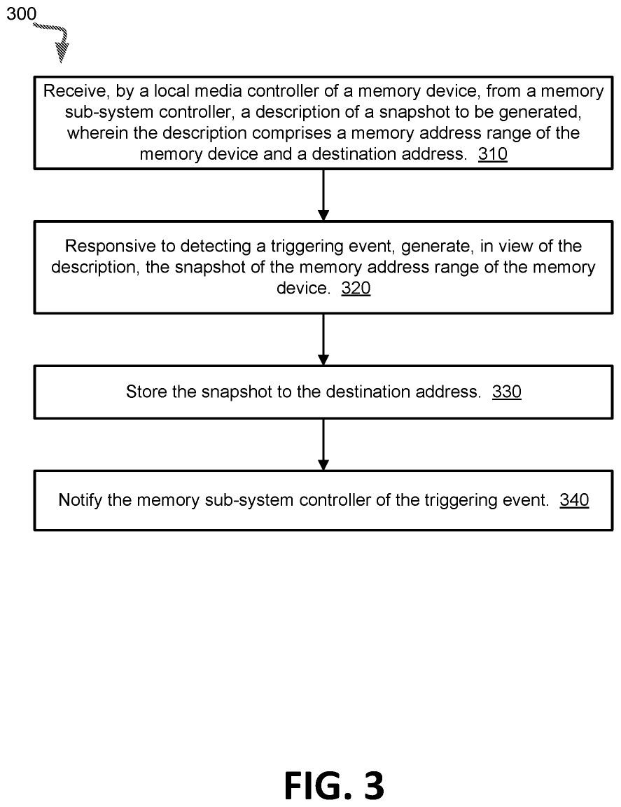

FIG. 3 is a flow diagram of an example method 300 to generate a snapshot of a memory device with hardware accelerated input/output path, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the snapshot description 137 of FIG. 1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing logic receives, by a local media controller of a memory device, from a memory sub-system controller, a description of a snapshot to be generated in response to detecting a triggering event. The description includes a memory address range of the memory device to be included in the snapshot, and a destination address at which to store the generated snapshot. The memory address range can be a list of starting physical addresses and corresponding sizes, indicating regions of the memory device that are to be included in the snapshot. In some embodiments, the processing logic can store the description of the snapshot to be generated in response to detecting the triggering event locally within the memory device. In some embodiments, the description can include a list of events (e.g., a list of error codes) that would trigger the snapshot generation process.

The processing device can also store an availability indicator associated with the description. The availability indicator indicates whether the destination address is available. For example, the availability indicator can be a single bit data field, and the processing logic can set the indictor to “0” if the destination address is available, and to “1” if the destination address is not available. The default setting can be “0,” indicating that the destination address is available. The destination address is not available if it is currently storing a snapshot that has not yet been stored to persistent memory.

At operation 320, responsive to detecting the triggering event, the processing logic generates, in view of the description, the snapshot of the memory address range of the memory device. The triggering event can be a failure of the memory device or an error of the memory device. The triggering event can include an identification of the triggering event, such as an error code. In some embodiments, prior to generating the snapshot, the processing logic determines that the availability indicator associated with the description indicates that the destination address is available. For example, the processing logic can determine whether the availability indicator associated with the destination address is set to “0,” indicating that the destination address is available, or set to “1,” indicating that the destination address is not available. If the destination address is available, the processing logic can proceed with generating the snapshot in view of the description, and then proceed to operation 330. If the destination address is not available, the processing logic can proceed to operation 340 and notify the memory sub-system controller of the triggering event, and can further notify the memory sub-system controller that the snapshot process failed. In some embodiments, the memory sub-system controller can generate a snapshot of the memory device in response to receiving a notification that the snapshot process failed.

At operation 330, the processing logic stores the snapshot to a destination address. In some embodiments, the destination address points to volatile memory. In some embodiments, responsive to storing the snapshot to the destination address, the processing logic updates the availability indicator associated with the description to indicate that the destination address is not available. This can avoid overwriting a snapshot before the snapshot is stored to persistent memory.

At operation 340, the processing logic notifies the memory sub-system controller of the triggering event. The notification can be an interrupt sent to the processor of the memory sub-system controller. The notification can include the identification of the triggering event, such as the error code. In some embodiments, the processing logic can receive, from the memory sub-system controller, a notification indicating completion of the snapshot. The notification can indicate that the snapshot has been successfully stored to persistent memory. The processing logic can then update the availability indicator associated with the description to indicate that the destination address is once again available. For example, the processing logic can update the availability indicator associated with the destination from “1” to “0.”

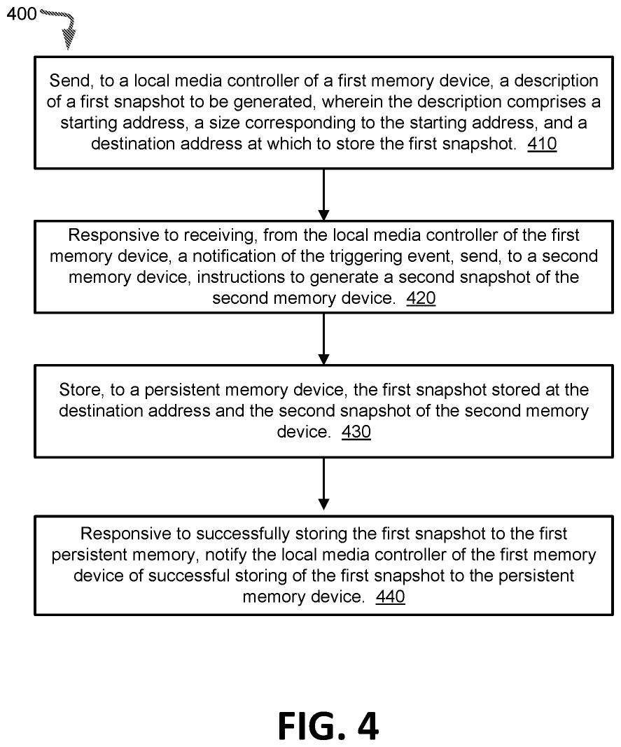

FIG. 4 is a flow diagram of an example method 400 to generate a comprehensive snapshot of a memory sub-system with hardware accelerated input/output path, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the snapshot manager component 113 of FIGS. 1A, 1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic sends, to a local media controller of a first memory device, a description of a first snapshot to be generated. The description can include a list of triggering events that can trigger the snapshot process, such as a list of error codes. The description can include a list of memory regions to include in the snapshot, for example, the description includes one or more starting addresses and a size corresponding to the starting addresses. The description also includes a destination address at which to store the first snapshot. In some embodiments, the processing logic designates a portion of volatile memory as a shared memory region at which memory devices can store generated snapshots. In some embodiments, the processing logic sends the description of the first snapshot during initialization of the first memory device. Additionally or alternatively, the processing logic sends the description of the first snapshot during initialization of the memory sub-system. The first memory device has a hardware accelerated input/output path.

At operation 420, responsive to receiving, from the local media controller of the first memory device, a first notification of the triggering event, the processing logic sends, to a second memory device, instructions to generate a second snapshot of the second memory device. In embodiments, the processing logic sends instructions to generate snapshots to more than one additional memory devices. The notification received from the local media controller of the first memory device can be a notification identifying the triggering event that resulted in the local media controller generating the first snapshot. In embodiments, the notification can be an interrupt. In embodiments, the notification can include an error code, which can identify the second memory device to be snapshotted. In embodiments, the processing logic receives, from the second memory device, a notification indicating the successful generating of the second snapshot. The notification can include a second destination address at which the second snapshot is stored.

In some embodiments, upon initialization of the memory sub-system, the processing logic can send a description of a snapshot to be generated to more than one memory device of the memory sub-system. Then, responsive to receiving a notification of the triggering event (e.g., an interrupt) from one of the memory devices, the processing logic, can send an instruction to generate a snapshot in view of the pre-defined description. The description sent to each memory device can include a distinct corresponding destination address within the shared memory region.

At operation 430, the processing logic stores, to a persistent memory device, the first snapshot stored at the destination address and the second snapshot of the second memory device. In some embodiments, the processing logic aggregates the first snapshot stored at the destination address and the second snapshot of the second memory device(s) into a comprehensive snapshot. The processing logic stores the comprehensive snapshot to the persistent memory device. In embodiments, the comprehensive snapshot includes an identification of the triggering event associated the notification. For example, the comprehensive snapshot includes an identification of the error code that triggered the first snapshot on the first memory device.

At operation 440, responsive to successfully storing the first snapshot to the persistent memory, the processing logic notifies the local media controller of the first memory device indicating the successful storing of the first snapshot to the persistent memory device.

In some embodiments, the memory sub-system controller can receive a notification from the local media controller of the triggering event, including an indication that the destination address is not available. That is, a local media controller of a memory device may have detected a triggering event, however prior to generating the snapshot, the local media controller may have determined that the availability indicator associated with the description of the snapshot indicates that the destination address is not available. In such a case, the local media controller of the memory device can notify the memory sub-system controller of the triggering event (e.g., by generating an interrupt), and can include an indication that the destination address is not available. Upon receiving such a notification, the memory sub-system controller can initiate a snapshot process of the memory device and store the snapshot directly to the persistent memory device.

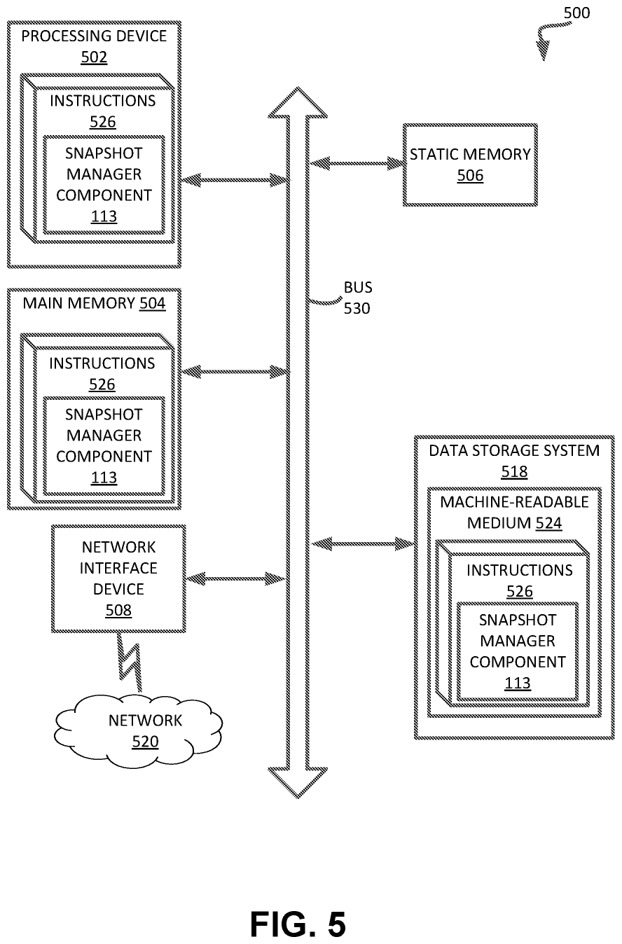

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to the snapshot manager component 113 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1A.

In one embodiment, the instructions 526 include instructions to implement functionality corresponding to a snapshot manager component (e.g., the snapshot manager component 113 of FIG. 1A). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
receiving, by a local media controller of a memory device, from a memory sub-system controller, a description of a snapshot to be generated, wherein the description comprises a memory address range of the memory device and a destination address;
responsive to detecting a triggering event, generating, by the local media controller, in view of the description, the snapshot of the memory address range;
storing the snapshot to the destination address; and
notifying the memory sub-system controller of the triggering event.

2. The method of claim 1, further comprising:
storing, to the memory device, the description of the snapshot; and
storing an availability indicator associated with the description, wherein the availability indicator indicates whether the destination address is available.

3. The method of claim 2, further comprising:
prior to generating the snapshot, determining that the availability indicator associated with the description indicates that the destination address is available.

4. The method of claim 2, further comprising:
responsive to storing the snapshot to the destination address, updating the availability indicator to indicate that the destination address is not available.

5. The method of claim 2, further comprising:
receiving, from the memory sub-system controller, a notification indicating successful storing of the snapshot to a persistent memory device; and
updating the availability indicator associated with the description to indicate that the destination address is available.

6. The method of claim 1, wherein the description comprises a starting address of the memory address range, and a size corresponding to the starting address.

7. The method of claim 1, wherein the triggering event comprises an identification of the triggering event, and wherein the triggering event is one of: a failure of the memory device or an error of the memory device.

8. A system comprising:
a plurality of memory devices; and
a processing device, operatively coupled with the plurality of memory devices, to perform operations comprising:
sending, to a local media controller of a first memory device, a description of a first snapshot to be generated, wherein the description comprises a starting address, a size corresponding to the starting address, and a destination address at which to store the first snapshot, and wherein the description comprises a list of one or more triggering events;
responsive to receiving, from the local media controller of the first memory device, a notification of a triggering event, sending, to a second memory device, instructions to generate a second snapshot of the second memory device; and
storing, to a persistent memory device, the first snapshot stored at the destination address and the second snapshot of the second memory device.

9. The system of claim 8, further comprising:
responsive to successfully storing the first snapshot to the persistent memory device, notifying the local media controller of the first memory device of successful storing of the first snapshot to the persistent memory device.

10. The system of claim 8, wherein the processing device sends the description of the first snapshot to be generated during initialization of the first memory device.

11. The system of claim 8, wherein the first memory device has an accelerated input/output path.

12. The system of claim 8, wherein storing, to the persistent memory device, the first snapshot stored at the destination address and the second snapshot of the second memory device further comprises:
aggregating the first snapshot stored at the destination address and the second snapshot into a comprehensive snapshot; and
storing the comprehensive snapshot to the persistent memory device, wherein the comprehensive snapshot comprises an identification of the triggering event associated with the notification.

13. The system of claim 8, wherein the notification received from the local media controller of the first memory device is an interrupt comprising an error code, and wherein the error code identifies the second memory device.

14. A non-transitory computer-readable storage medium comprising instructions that, when executed by a processing device, cause the processing device to perform operations comprising:
receiving, by a local media controller of a memory device, from a memory sub-system controller, a description of a snapshot to be generated, wherein the description comprises a memory address range of the memory device and a destination address;
responsive to detecting a triggering event, generating, by the local media controller, in view of the description, the snapshot of the memory address range;
storing the snapshot to the destination address; and
notifying the memory sub-system controller of the triggering event.

15. The non-transitory computer-readable storage medium of claim 14, wherein the processing device is to perform operations further comprising:
storing, to the memory device, the description of the snapshot; and
storing an availability indicator associated with the description, wherein the availability indicator indicates whether the destination address is available.

16. The non-transitory computer-readable storage medium of claim 15, wherein the processing device is to perform operations further comprising:
prior to generating the snapshot, determining that the availability indicator associated with the description indicates that the destination address is available.

17. The non-transitory computer-readable storage medium of claim 15, wherein the processing device is to perform operations further comprising:
responsive to storing the snapshot to the destination address, updating the availability indicator to indicate that the destination address is not available.

18. The non-transitory computer-readable storage medium of claim 15, wherein the processing device is to perform operations further comprising:
receiving, from the memory sub-system controller, a notification indicating completion of the snapshot to a persistent memory device; and
updating the availability indicator associated with the description to indicate that the destination address is available.

19. The non-transitory computer-readable storage medium of claim 14, wherein the description comprises a starting address of the memory address range, a size corresponding to the starting address, and the destination address.

20. The non-transitory computer-readable storage medium of claim 14, wherein the triggering event comprises an identification of the triggering event, and wherein the triggering event is one of: a failure of the memory device or an error of the memory device.
